(19) United States
(12) Patent Application Publication
(10) Pub. No.: US 2017/0228815 A1
(43) Pub. Date: Aug. 10, 2017

(54) METHODS, SYSTEMS, AND MEDIA FOR PROVIDING AGGREGATED AND UNIFORMLY ARRANGED ITEM INFORMATION

(71) Applicant: LastMile Retail, Inc., Astoria, NY (US)

(72) Inventors: William H. Plaehn, Long Island City, NY (US); Michael T. Carini, Astoria, NY (US)

(21) Appl. No.: 15/428,022

(22) Filed: Feb. 8, 2017

Related U.S. Application Data
(60) Provisional application No. 62/292,834, filed on Feb. 8, 2016.

(51) Int. Cl. G06Q 30/06; G06Q 10/08

(52) U.S. Cl. CPC G06Q 30/0639; G06Q 10/087

(57) ABSTRACT

Methods for providing aggregated and uniformly arranged item information are provided, comprising: receiving at a local computing device, from each of a plurality of item sources, item information for each of a plurality of items, wherein the item information from each item source is in a different format; transforming the item information from at least one of the item sources into a common format; receiving a location identifier; receiving at least one parameter including at least one of an item identifier and a source identifier, wherein the item identifier identifies at least one of the items, and wherein the source identifier identifies at least two of the item sources; selecting item information based on the at least one parameter and the location identifier; aggregating the selected item information and arranging the aggregated item information into a uniform format; and transmitting the arranged information to a remote computing device.

### CROSS REFERENCE TO RELATED APPLICATION

This application claims the benefit of U.S. Provisional Patent Application No. 62/292,834, filed Feb. 8, 2016, which is hereby incorporated by reference herein in its entirety.

### TECHNICAL FIELD

The present disclosure relates generally to inventory data, and more particularly to a digital system and method for obtaining, transforming, displaying, and syndicating inventory data for retailers with physical presence.

### BACKGROUND

Physical store product availability information (e.g. inventory, warehouse stock, etc.) has traditionally been constrained to usage in store operations for the purposes of merchandising, restock, and financial accounting and forecasting. As consumers increasingly use the Internet to research and plan their purchases, they increasingly desire local product availability information online.

However, today's retailers universally employ e-commerce website frameworks that are analogous to offline shopping catalogs (e.g., the Sears Catalog). These websites are designed for mail-order only, and use an organizational hierarchy and data-structure that is explicitly agnostic to a product's physical location in order to appeal and sell to consumers regardless of geography. This architecture, however, fails to address many of the needs that are relevant to a business with physical locations, such as providing a method to browse in-store inventory. Such needs can only be addressed by new solutions with no physical analog.

Acknowledging this issue, some more sophisticated retailers have attempted to address the architectural shortcomings of their e-commerce sites with find-in-store modules that check the in-store stock of products originally listed for mail-order sale.

These modules are lacking from a usability perspective because they only allow a user to query the availability of a single product, there is no capability to vertically or horizontally browse the inventory available in a group of stores or single store location. Accordingly, they do not enhance the navigation or change the structure of e-commerce web sites, and may be compared to calling a phone number to check the stock of a product listed in a catalog.

Accordingly, new mechanisms for presenting inventory information are desirable.

### SUMMARY

Methods, systems, and media for providing aggregated and uniformly arranged item information are provided.

In some embodiments, methods for providing aggregated and uniformly arranged item information are provided, the methods comprising: receiving at a local computing device, from each of a plurality of item sources, item information for each of a plurality of items, wherein the item information from each of the plurality of item sources is in a different format; transforming the item information from at least one of the plurality of item sources into a common format; receiving a location identifier; receiving at least one parameter including at least one of an item identifier and a source identifier, wherein the item identifier identifies at least one of the plurality of items, and wherein the source identifier identifies at least two of the plurality of item sources; selecting item information based on the at least one parameter and the location identifier; aggregating the selected item information and arranging the aggregated item information into a uniform format; and transmitting the arranged information from the local computing device to a remote computing device.

In some embodiments, systems for providing aggregated and uniformly arranged item information are provided, the systems comprising: a memory; and at least one hardware processor configured to: receive from each of a plurality of item sources, item information for each of a plurality of items, wherein the item information from each of the plurality of item sources is in a different format; transform the item information from at least one of the plurality of item sources into a common format; receive a location identifier; receive at least one parameter including at least one of an item identifier and a source identifier, wherein the item identifier identifies at least one of the plurality of items, and wherein the source identifier identifies at least two of the plurality of item sources; select item information based on the at least one parameter and the location identifier; aggregate the selected item information and arrange the aggregated item information into a uniform format; and transmit the arranged information to a remote computing device.

In some embodiments, non-transitory computer-readable media containing computer executable instructions that, when executed by a processor, cause the processor to perform a method for providing aggregated and uniformly arranged item information are provided, the method comprising: receiving at a local computing device, from each of a plurality of item sources, item information for each of a plurality of items, wherein the item information from each of the plurality of item sources is in a different format; transforming the item information from at least one of the plurality of item sources into a common format; receiving a location identifier; receiving at least one parameter including at least one of an item identifier and a source identifier, wherein the item identifier identifies at least one of the plurality of items, and wherein the source identifier identifies at least two of the plurality of item sources; selecting item information based on the at least one parameter and the location identifier; aggregating the selected item information and arranging the aggregated item information into a uniform format; and transmitting the arranged information from the local computing device to a remote computing device.

### BRIEF DESCRIPTION OF THE DRAWINGS

The above and other aspects, features and advantages of certain embodiments will be more apparent from the following detailed description taken in conjunction with the accompanying drawings, in which:

FIG. 1 illustrates an example of a block diagram of a mechanism for data transformation, display, and syndication in accordance with some embodiments.

FIG. 2 illustrates an example of a block diagram of a mechanism for transformation selection and application in accordance with some embodiments.

FIG. 3 illustrates an example of a block diagram of a mechanism for data transformation management in accordance with some embodiments.

FIG. 4 illustrates an example of a block diagram of a mechanism for generating landing pages related to localized inventory information in accordance with some embodiments.

FIG. 5 illustrates an example of a flow chart of a mechanism for presenting a user interface in accordance with some embodiments.

FIG. 6 illustrates an example of a user interface in accordance with some embodiments.

FIG. 7 illustrates an example of another user interface in accordance with some embodiments.

FIG. 8 illustrates an example of still another user interface in accordance with some embodiments.

FIG. 9 illustrates an example of a flow diagram of a mechanism for presenting a user interface in accordance with some embodiments.

While some embodiments are described herein in connection with the above-referenced drawings, the drawings are only intended to be illustrative and not limiting, and other embodiments can be implemented.

### DETAILED DESCRIPTION

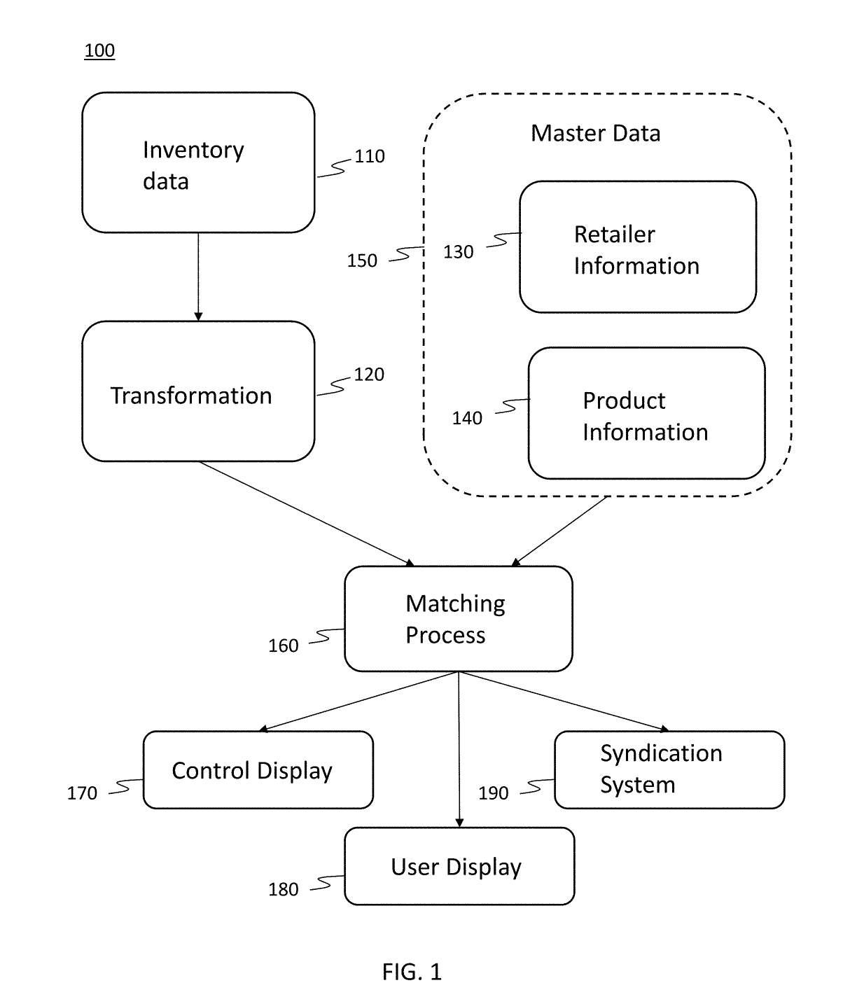

FIGS. 1-9 illustrate examples of mechanisms for data acquisition, transformation, and presentation that can be provided in accordance with some embodiments. As used herein, mechanisms can include systems, method, media, hardware, software, and/or any other suitable technique(s) to implement the functions described herein.

While several embodiments have been disclosed, it will be apparent to those of ordinary skill in the art that aspects of the present invention include many more embodiments and implementations. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

As will be appreciated by one skilled in the art, aspects of the present invention can be embodied as a system, method, or computer program product. Accordingly, aspects of the present invention can take the form of an entirely hardware embodiment, an entirely software embodiment (including firmware, resident software, micro-code, etc.), or an embodiment combining software and hardware aspects that can all generally be referred to herein as a “circuit,” “module” or “system.” Furthermore, aspects of the present invention can take the form of a computer program product embodied in one or more computer readable medium(s) having computer readable program code embodied thereon. It should also be noted that, as used herein, the term mechanism can encompass hardware, software, firmware, or any suitable combination thereof.

In some implementations, any suitable computer readable media can be used for storing instructions for performing the functions and/or processes described herein. For example, in some implementations, computer readable media can be transitory or non-transitory. For example, non-transitory computer readable media can include media such as non-transitory forms of magnetic media (such as hard disks, floppy disks, etc.), non-transitory forms of optical media (such as compact discs, digital video discs, Blu-ray discs, etc.), non-transitory forms of semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Computer program code for carrying out operations for aspects of the present invention can be written in any combination of one or more programming languages, including an object oriented programming language such as Java, Smalltalk, C++, Python, or the like and conventional procedural programming languages, such as the “C” programming language or any type of programming languages such as, inter alia, an assembly language. The program code can execute entirely on the user's device, partly on the user's device, as a stand-alone software package, or on a web server.

In some embodiments, one or more blocks of the flow diagrams provided herein can be implemented by computer program instructions. These computer program instructions can be provided to a hardware processor of a general purpose computer, special purpose computer, or other programmable data processing apparatus to produce a machine in some embodiments. In some embodiments, the instructions, which can be executed via a hardware processor of a computer or other programmable data processing apparatus, can create a means for implementing the functions/acts specified in the flowchart and/or block diagram block or blocks. Additionally, aspects of the functions/acts may be “hard coded” to perform a step with limited external input in some embodiments.

In some embodiments, computer program instructions can be stored in a computer readable medium (which can be non-transitory or transitory) that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

In some embodiments, computer program instructions can be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Flowcharts and block diagrams in the figures can be used to illustrate the architecture, functionality, and operation of possible implementations of systems, methods and computer program products according to various embodiments. In this regard, each block in the flowchart or block diagrams can represent a module, segment, or portion of code, which may include one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The description of various embodiments provided herein has been presented for purposes of illustration and description, but is not intended to be exhaustive or limit the scope of the invention to the embodiments disclosed. Many modifications and variations will be apparent to those of ordinary skill in the art without departing from the scope and spirit of the invention.

FIG. 1 illustrates an example 100 of a system for applying a transformation 120 to inventory data 110, and applying a matching process 160 to master data 150 and the output of transformation 120 in accordance with some embodiments. Master data 150 can include retailer information 130 and product information 140 in some embodiments. The status of the matching process can be displayed on control display 170, which also can manage the various steps of system 100 by way of sending or receiving control signals, in some embodiments. The result of the matching process can be composed for display on user display 180 in some embodiments. A syndication system 190 may notify or push data to third party systems or to components of system 100 in some embodiments.

In some embodiments, inventory data 110 may include but is not limited to count, names, identifiers, descriptions, specifications, images, video content, instructional documents, marketing material, reviews, ratings, pricing information, marks, promotional content, marketing content, contact information, business terms, transaction records, customer lists, payment methods, related services provided, or purchase options.

Inventory data 110 may originate from a variety of sources including but not limited to accounting systems, point of sale systems, inventory management systems, distributor records, distributor websites, distributor catalogs, brand records, brand websites, brand catalogs, manufacturer records, manufacturer websites, manufacturer catalogs, retailer records, retailer websites, retailer catalogs, proprietary software resident on client systems in the form of a stand-alone application or plug-in, or from output steps of system 100, in some embodiments.

Inventory data 110 may be acquired by way of a variety of methods, including manual entry, interfacing with a web-based application programming interface (API), receiving a request to consume data via a web-based API (e.g., receiving a POST request), or downloading a hypertext web page with a computer program. Inventory data 110 may be stored in a file system, database, and the like, or in any combination thereof, in some embodiments.

Transformation 120 can enable inventory data 110 to be matched to master data 150 in some embodiments. Transformation 120 may include any number of steps including but not limited to changing format, correcting spelling errors, correcting format errors, changing data based on a map, adding additional data, removing data, incorporating data originating from system 100, producing metadata about transformation steps or statuses, executing a function to produce an output, or executing the identity function (i.e., doing nothing), in some embodiments. The output of transformation 120 may be saved in a file system, database, and the like, or in any combination thereof for future access, in some embodiments.

In some embodiments, master data 150 may include but is not limited to names, identifiers, descriptions, specifications, images, video content, instructional documents, marketing material, reviews, ratings, pricing information, marks, promotional content, marketing content, contact information, physical addresses, location descriptions, business terms, transaction records, customer lists, demographic information, population information, payment methods, related services provided, or purchase options. Master data 150 may be stored in a file system, database, and the like, or in any combination thereof, in some embodiments.

In some embodiments, master data 150 may originate from a single source or plurality of sources including but not limited to accounting systems, point of sale systems, inventory management systems, distributor records, distributor websites, distributor catalogs, brand records, brand websites, brand catalogs, manufacturer records, manufacturer websites, manufacturer catalogs, retailer records, retailer websites, retailer catalogs, proprietary software resident on client systems in the form of a stand-alone application or plug-in, or from output steps of system 100.

Master data 150 may be acquired by way of a variety of methods, including but not limited to manual entry, interfacing with a web-based application programming interface (API), or downloading a hypertext web page with a computer program (i.e., may be acquired by the same methods possibly acquiring inventory data 110), in some embodiments. Master data 150 may be pre-processed with transformation steps including but not limited to the steps that may be included in transformation 120, in some embodiments.

In some embodiments, matching process 160 can enable a composition of inventory data 110 and master data 150. Matching process 160 may include any number of steps including but not limited to applying a mapping of field names relating one source to another, creating or updating a mapping of values automatically or manually, performing lookups (such as database queries), and fuzzy matching techniques between any number of fields of inventory data 110 and master data 150, in some embodiments. Those skilled in the art will appreciate that such a mapping may be implemented with a variety of methods, such as storing values in a database, file system, or the like, by writing software with functions related to particular data sources, or a combination thereof, in some embodiments.

The output of matching process 160 can represent product, retailer, and inventory information and may be used to update master data 150 to reduce processing steps in future applications of system 100, in some embodiments. The output of matching process 160 may also comprise producing metadata about transformation steps or statuses, or executing a function to produce an output, in some embodiments. The output of matching process 160 may be saved in a file system, database, and the like, or in any combination thereof for future access, in some embodiments.

Control display 170 can enable an end-user (i.e., a human or machine agent) to holistically monitor the status of system 100, in some embodiments. End-users may more specifically include consumers, business users, or machine users of various or no permissions with respect to authentication systems (not depicted) within system 100, in some embodiments. The statuses of acquisitions, transformations, and matching processes as well as related data sources may be displayed on control display 170, in some embodiments. Such statuses may include dates, success metrics, change metrics, frequencies, schedules, error details, or the like, in some embodiments. Control display 170 may be implemented by a variety of methods, including but not limited to a web interface, web application, web server, database, API, mobile application, or computer program, in some embodiments. Access to control display 170 may be restricted by an authentication system, in some embodiments.

Control display 170 can supply input to components of system 100, such as input to matching process 160 to manually update a mapping of values or such as input to initiate, stop, schedule, or otherwise control acquisitions, transformations, and matching processes related to a single data source or plurality of data sources, in some embodiments.

User display 180 can display the output of matching process 160 so that end-users can interact with inventory, product, and retailer information, in some embodiments. User display 180 may be implemented by a variety of methods, including but not limited to a web interface, web application, web server, database, API, mobile application, or computer program, in some embodiments.

User display 180 can present a set of pages related to each retailer to the end-user, and each set may include but is not limited to a retailer profile page, list pages containing sets of the retailer's products, product detail pages for each of the products in the retailer's inventory, in some embodiments. User display 180 can also present a set of pages that represent the aggregate set of products available within a distance of a given location to the end-user, the set may include but is not limited to a location profile page, list pages containing sets of products, or list pages containing sets of retailers, in some embodiments. Those skilled in the art will appreciate that such pages may incorporate navigation links between one another in a fashion to enable end-users to navigate the set of pages to achieve a goal, in some embodiments.

User display 180 can enable a variety of page navigation methods, such methods may include but are not limited to refining results according to product attributes, refining results according to retailer attributes, searching, selecting a category, selecting a brand, selecting a retailer, displaying a list of retailers related to a composition of page navigation methods, or displaying a list of products related to a composition of page navigation methods, in some embodiments.

User display 180 can enable a variety of embedded page interaction methods, such methods may include but are not limited to obtaining location data via a location data acquisition process, storing personal information (e.g., creating an account), storing payment methods, storing preferences for repeated use with services and functions, purchasing items, sharing information with third party applications or services to enable specific functionality, and selecting fulfillment options, in some embodiments. These embedded page interaction methods may be optionally displayed depending on whether or not they are supported for a given navigation context or information set including but not limited to product information, inventory information, and retailer information, in some embodiments. For example, user display 180 can enable a particular set of interaction methods for a given product at a specific retailer based on the services that the retailer supplies for that given product, in some embodiments.

User display 180 may present a variety of information designed to be consumed by third party applications or services, in some embodiments. Such information may include but is not limited to product information, retailer information, order information, transaction information, credit card information, contact information, addresses, phone numbers, personal identifiers, names, or account names, in some embodiments. This information may be shared to enable specific functionality to end-users such as buy online and ship, buy online for in-store pickup, payment processing, delivery of goods, booking appointments, requesting a service, requesting a return, returning an item, or invoking a warranty, in some embodiments. The mechanism by which user display 180 shares information may include but is not limited to API, email, text message, web interface, mobile application, or by proxy of a human agent, in some embodiments.

User display 180 may employ mechanisms of data organization to make inventory, product, and retailer information accessible and understandable by machine agents, in some embodiments. These mechanisms may include but are not limited to hypertext tags, JavaScript objects and methods, microformats, microdata, resource description framework in attributes (RDFa), sitemaps, data feeds, API endpoints, or structured data such as are specified by schema.org, in some embodiments. These mechanisms may employ data including but not limited to names, brands, manufacturers, model numbers, categories, features, descriptions, specifications, retailers, addresses, services available, or embedded page interaction methods, in some embodiments.

User display 180 may present an interactive dashboard to end-users that displays information, contexts, and functions about user accounts and related activity, in some embodiments. End-users may have a relation to any number of products or retailers within system 100, in some embodiments. Based on the identity or lack thereof of the end-user, and optionally an authentication system, different sets of information, contexts, and functions may be displayed and accessed, in some embodiments. This information may include but is not limited to past orders, page views, interaction method invocations, dollar values, pricing information, advertising campaign information, advertising campaign metrics, promotional information, sale information, product information, retailer information, or information provided by a third party service, in some embodiments. The contexts may include but are not limited sets of retailers, sets of products, sets of user accounts, user identifiers, user demographics, or physical locations, in some embodiments. The functions may include but are not limited to adding, updating, or removing inventory, retailers, products, orders, user accounts, user identifiers, addresses, availability of services, promotions, sales, or advertising campaign, in some embodiments s. The functions may be facilitated by a what-you-see-is-what-you-get (WYSIWYG) interface, file uploads, API endpoints that other systems can exchange data with, or the like, in some embodiments.

Syndication system 190 may include a plurality of mechanisms related to, inter alia, sharing data with other systems or third parties for purposes including digital advertising, traditional advertising, social media, marketplace syndication, updating websites, notifying end-users, or data display, in some embodiments. The data that can be syndicated may include sets of portions of product, retailer, inventory information, or the output of matching process 160, in some embodiments. Syndication logic may be applied to determine sharing mechanisms or parameters for sharing mechanisms, as in the case of digital advertising (e.g., a product and retailer may be passed as parameters to a determined sharing mechanism to place an advertisement with a digital medium), in some embodiments. Such syndication logic may factor but is not limited to factoring targeting demographics, usage metrics, third party demographics data, or manual input by an end-user, in some embodiments. The mechanism by which syndication system 190 shares information may include but is not limited to API, email, text message, web interface, mobile application, or proxy of a human agent, in some embodiments. Syndication system 190 may differ from user display 180 in that the syndication system actively notifies third parties that it is sharing data with versus reacting to requests for information, in some embodiments. An active notification originating from syndication system 190 may also be used to indicate that a third party should subsequently access an aspect of user display 180, in some embodiments. User display 180 may alternatively consume data yielded by matching process 160 via syndication system 190, in some embodiments.

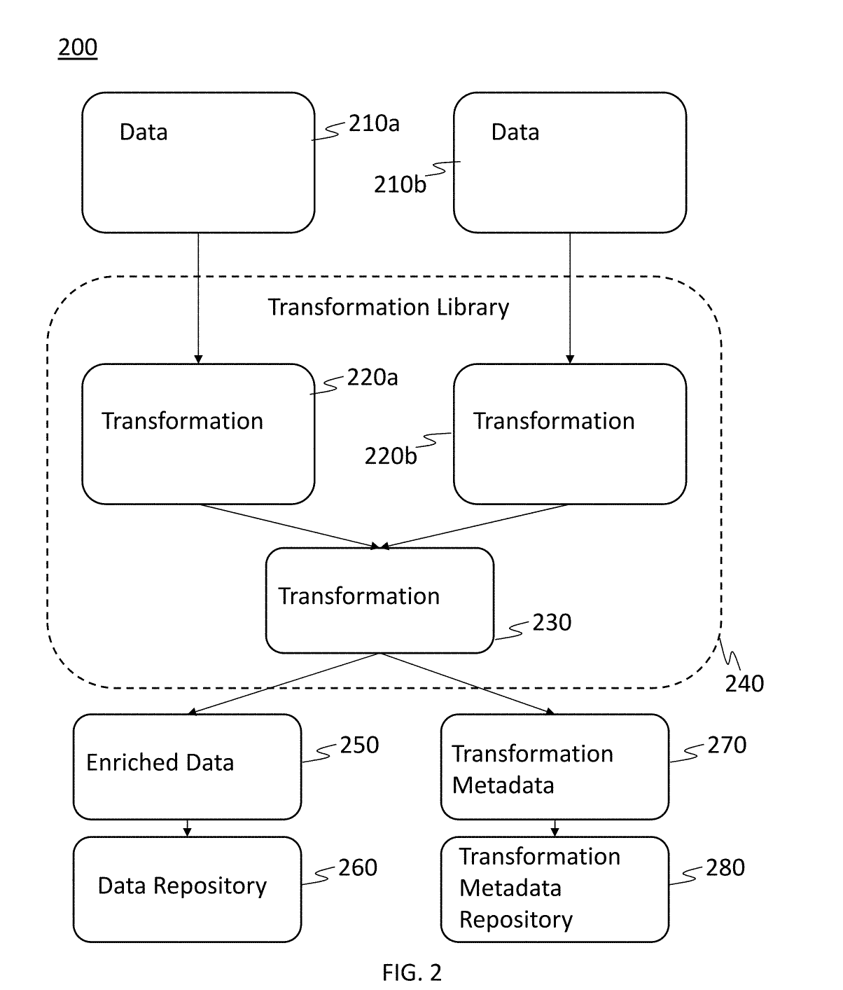

FIG. 2 illustrates an example 200 of a system for selecting and applying transformation 220a and transformation 220b from transformation library 240 to data 210a and data 210b in accordance with some embodiments. The outputs of transformation 220a and transformation 220b can be supplied to transformation 230 to produce enriched data 250 and transformation metadata 270, in some embodiments. Enriched data 250 can be stored in data repository 260 for later use, in some embodiments. Transformation metadata 270 can be stored in transformation metadata repository 280 for later use, in some embodiments.

Data 210a may originate from any of the sources previously mentioned that relate to inventory data or master data, or other information within system 100, not shown, and can be equivalent to the inventory data or master data in system 100, also not shown, in some embodiments. Data 210a may be saved in a file system, database, and the like, or in any combination thereof for future access, in some embodiments.

Transformation 220a can be selected based on data 210a, in some embodiments. Selection may be performed by referencing a pre-determined mapping of data sources to transformations (e.g., a POST request to a particular endpoint or a particular website maps to a transformation to sanitize the POST request, or a particular hypertext page maps to a parsing transformation to extract particular attributes), determination and analysis of characteristics of data 210a (e.g., data format or presence of specific contents), or by manual selection, in some embodiments. Characteristics of data 210a may include but are not limited to format, content, or source, in some embodiments. Transformation 220a may include any number of steps including but not limited to changing of format, correcting spelling errors, correcting format errors, changing data based on a map, adding additional data, removing data, incorporating data originating from system 100, producing metadata about transformation steps or statuses, executing a function to produce an output, executing the identity function (i.e., doing nothing), applying a mapping of field names from one source to another, creating or updating a mapping of values automatically or manually, performing lookups (such as database queries), or fuzzy matching techniques, in some embodiments. The output of transformation 220a may be saved in a file system, database, and the like, or in any combination thereof for future access, in some embodiments. Those skilled in the art will appreciate that such a mapping may be implemented with a variety of methods, such as storing values in a database, file system, or the like, by writing software with functions related to particular data sources, or a combination thereof, in some embodiments.

Data 210b and transformation 220b are provided in FIG. 2 to illustrate that process 200 can process a plurality of data sources and transformations, in some embodiments. Those skilled in the art will appreciate that any suitable number (including only one) of data originating from any suitable number (including only one) of data sources may be processed by system 200, in some embodiments.

Transformation 230 can be a subsequent transformation applied to the outputs of transformation 220a and transformation 220b, or plurality of like transformations, in some embodiments. Transformation 230 may be selected by the same set of mechanisms that select transformation 220a with the addition of optionally referencing a pre-determined mapping of sets of transformations to sets of transformations, and may include the same set of steps, such as the identity function, that are included in transformation 220a, in some embodiments. Transformation 230 can yield enriched data 250 and transformation metadata 270, in some embodiments. Those skilled in the art will appreciate that such a mapping may be implemented with a variety of methods, such as storing values in a database, file system, or the like, by writing software with functions related to particular data sources, or a combination thereof, in some embodiments.

Transformation library 240 may include a collection of transformations that can be selected for use by system 200, in some embodiments.

Enriched data 250 may represent product, retailer, or inventory information as well as master data as described in system 100, in some embodiments.

Data repository 260 can store enriched data 250 for future access by systems, not depicted in FIG. 2, such as control display systems, user display systems, and syndication systems, in some embodiments. Data repository 260 may be a file system, database, and the like, or in any combination thereof, in some embodiments. Data repository 260 may function as a source of data 210a or 210b, in some embodiments.

Transformation metadata 270 may represent information related to any of the transformations 220a, 220b, or 230 as well as their inputs data 210a and data 210b (or plurality of like data and transformations), in some embodiments. This may include aggregate information about data 210a and data 210b, success metrics, counts, statuses, cached functions, timestamps, or progresses, in some embodiments.

Transformation metadata repository 280 can store transformation metadata 270 for future access by systems, not depicted, such as control display systems, user display systems, and syndication systems, in some embodiments. Transformation metadata repository 280 may be a file system, database, and the like, or in any combination thereof, in some embodiments. Transformation metadata repository 280 can function as a source of data 210a or 210b, in some embodiments.

In an example application of the system in FIG. 2, in accordance with some embodiments, Data 210a may be item information and Data 210b may be a different set of item information in a different format, each originating from a different item source. Transformations 220a, 220b, and 230 can be applied to convert Data 210a and Data 210b into a common format, Enriched Data 250, that is stored in Data repository 260, in some embodiments. Transformations 220a, 220b, and 230 can additionally yield representations of the item sources, Transformation metadata 270, to be stored in Transformation metadata repository 280, in some embodiments.

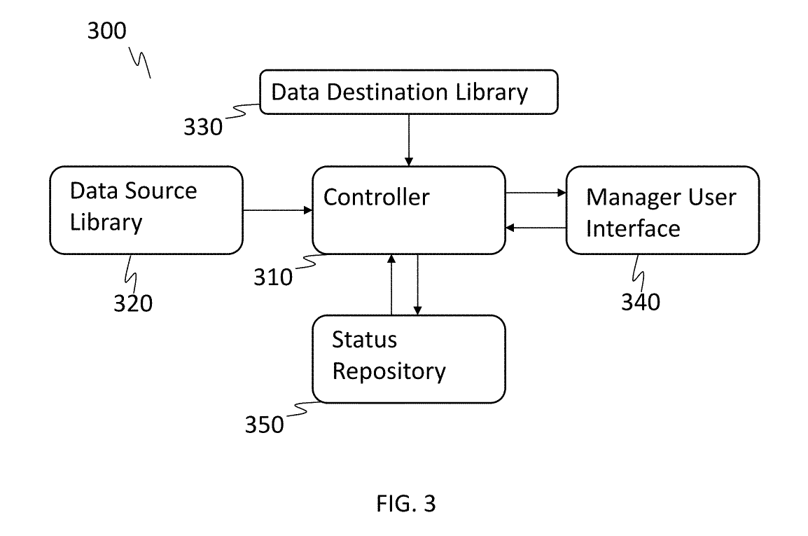

FIG. 3 illustrates an example 300 of a system for controlling data acquisition and distribution in accordance with some embodiments. A controller 310 can process a data source from data source library 320, and the output of processing may be again processed in conjunction with a data destination from data destination library 330, in some embodiments. Manager user interface 340 can enable display of the status of each processing, representations of data sources that reside in data source library 320, and data destinations that reside in data destination library 330, in some embodiments. Manager user interface 340 can be used to trigger processing of data sources or data destinations, in some embodiments. Status repository 350 can store the outputs of processing data sources or data destinations to provide state awareness to the controller, in some embodiments.

Controller 310 can manage the selection and sequencing of data sources from data source library 320 and data destinations from data destination library 330, in some embodiments. Controller 310 may contain common functions for performing data operations such as structuring web API requests, submitting web API requests, reading files, writing files, or performing database queries, in some embodiments. The common functions can be executed in isolation or factoring input originating from data source library 320, data destination library 330, manager user interface 340, or status repository 350, in some embodiments. Controller 310 can also execute functions originating from data source library 320, data destination library 330, manager user interface 340, or status repository 350, in some embodiments. The execution of the set of functions defined by a data source or data destination is referred to as processing.

Data source library 320 can represent a collection of data sources, not depicted, that can be processed, in some embodiments. A data source may contain a collection of functions, programming logic, transformation logic, authentication information, web addresses, sequencing information, files, or data, in some embodiments. When a data source is processed by controller 310, its output or metadata about the processing event such as time, date, source name, completion status, counts, composite information, processed information, cached functions, files, or metrics can be stored within status repository 350, in some embodiments. Processing of a data source may factor information from status repository 350, including but not limited to information originating from other data sources or destinations, in some embodiments. The purpose of data sources is to abstract the set of programmatic or manual steps of acquiring and transforming data from systems, in some embodiments.

Data destination library 330 can represent a collection of data destinations, not depicted, that can be processed, in some embodiments. A data destination may contain a collection of functions, programming logic, transformation logic, authentication information, web addresses, sequencing information, files, or data, in some embodiments. When a data destination is processed by controller 310, its output or metadata about the processing event such as time, date, source name, completion status, counts, composite information, processed information, cached functions, files, or metrics can be stored within status repository 350, in some embodiments. Processing of a data destination can factor information from status repository 350, including but not limited to information originating from other data sources or destinations, in some embodiments. The purpose of data destinations is to abstract the programmatic or manual steps of sending data to or triggering the consumption of data by downstream systems, in some embodiments.

Manager user interface 340 can provide a method for an end-user or software application to choose, initiate, or monitor the processing of data sources from data source library 320 or data destinations from data destination library 330, in some embodiments. It can display any information originating from components of system 300 as well as controls related to the information, in some embodiments. Information may be metadata generated by processing events stored within status repository 350, in some embodiments. For example, the name of a data source can be displayed along with its past processing history, metrics about past processing events, and controls to initiate new processing events, in some embodiments. Also, for example, a manual activity for an end-user to perform related to an incomplete processing event can be displayed and performed, influencing the incomplete processing event, in some embodiments.

Status repository 350 can store information and metadata related to processing events, data source library 320, data destination library 330, or manager user interface 340, in some embodiments. Status repository 350 can be implemented by a file system, database, and the like, or in any combination thereof, in some embodiments.

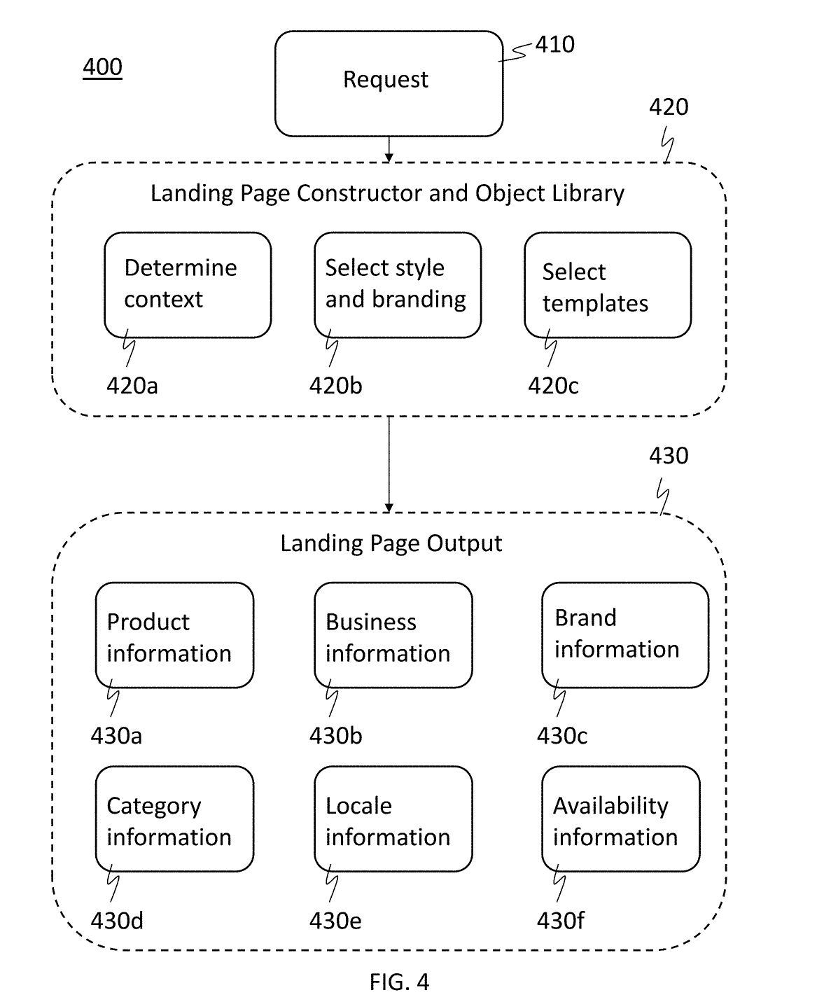

FIG. 4 illustrates an example 400 of a system for generating landing pages related to localized inventory information in accordance with some embodiments. A request 410 can be received by landing page constructor and object library 420, in some embodiments. Landing page constructor and object library 420 can implement steps determine context 420a, select style and branding 420b, and select templates 420c, in some embodiments. The output of landing page constructor can be landing page output 430, in some embodiments. The output may comprise product information 430a, business information 430b, brand information 430c, category information 430d, locale information 430e, or availability information 430f, in some embodiments.

Request 410 may originate from a human user or machine user, i.e., the request initiator, by way of a device via a web interface, in some embodiments. The device may be any internet-enabled device, inter alia, a cell phone, smart phone, personal computer, cloud-based computer, in some embodiments. Request 410 contains a plurality of information comprising information required to determine the context of the request, in some embodiments. This comprising information may include geographic coordinates, search queries, product identifiers, business identifiers, brand identifiers, category identifiers, locale identifiers, or group identifiers, wherein said identifiers refer to identifiers of their respective objects within landing page constructor and object library 420, in some embodiments.

Landing page constructor and object library 420 can include implementations of steps determine context 420a, select style and branding 420b, and select templates 420c, in some embodiments. Upon receiving request 410, landing page constructor and object library 420 can determine a set of implemented steps to execute, factoring request 410 as part of the input, in some embodiments. Landing page constructor and object library 420 can contains objects, not depicted, relating to products, businesses, brands, categories, locales, or groups, in some embodiments. These objects can contain information that can include but is not limited to names, descriptions, specifications, location information, addresses, contact information, phone numbers, email addresses, social media links, images, videos, marks, files, styles, templates, or relationships between one-another, in some embodiments. Landing page constructor and object library 420 can be implemented by computer systems including one or multiple of web servers, databases, file systems, load balancers, computer programming languages, or caching systems, in some embodiments.

Step determine context 420a can include executing a set of parsing logic that maps the information within request 410 to objects within landing page constructor and object library 420, in some embodiments. Step determine context 420a may also include additional information gathering steps to complete the request or indicate the request initiator should undergo a procedure that includes submitting a new request (e.g., a location collection procedure), in some embodiments. Additionally, step determine context 420a may employ methods of entity resolution including but not limited to applying a value mapping or applying fuzzy matching techniques to the information within request 410, in some embodiments.

Step select style and branding 420b can use the information within request 410 or the object mapping from determine context 420a to determine a style, branding, or theme to apply to the output, in some embodiments. The style and branding, or theme can include but is not limited to metadata, CSS files, template selection overrides, or logo substitutions, in some embodiments.

Step select templates 420c can use the information within request 410, the object mapping from determine context 420a, or the output of select style and branding 420b to select a set of templates to apply to the object mapping from step determine context 420a, in some embodiments. Templates, not depicted, may be sets of HTML and variable (i.e., data-driven based on objects within landing page constructor and object library 420) content that are common to structuring components of a user interface, including machine-readable components, in some embodiments. Templates may be previously saved in a file system, database, and the like, or in any combination thereof for access, and may reside within landing page constructor and object library 420, in some embodiments.

Landing page output 430 illustrates an output to be served to the request initiator, in some embodiments. It can include characteristics of system 100, not depicted, specifically those related to user display 180, in some embodiments. Examples of landing pages can include, inter alia, a product-at-business landing page, wherein a product is displayed to the request initiator along with details about the business that carries it, the stock status of the product, a button to buy online for pickup in store, information about the product's brand, and a list of nearby or related locales that are relevant to the business's physical location, in some embodiments.

Product information 430a may include information aspects related to products, inter alia, product names, product descriptions, or product images, in some embodiments. Product information 430a may include but is not limited to count, names, identifiers, descriptions, specifications, images, video content, instructional documents, marketing material, reviews, ratings, pricing information, marks, promotional content, marketing content, contact information, business terms, payment methods, related services provided, or purchase options, in some embodiments.

Business information 430b may include information aspects related to businesses, inter alia, business names, business descriptions, addresses, geographic coordinates, business terms, or images, in some embodiments. Business information 430b may include but is not limited to count, names, identifiers, descriptions, specifications, images, video content, instructional documents, marketing material, reviews, ratings, pricing information, marks, promotional content, marketing content, contact information, business terms, transaction records, customer lists, payment methods, related services provided, or purchase options, in some embodiments.

Brand information 430c may include information aspects related to brands or manufacturers of products, inter alia, brand names, brand descriptions, in some embodiments. Brand information 430c may include but is not limited to count, names, identifiers, descriptions, specifications, images, video content, instructional documents, marketing material, reviews, ratings, pricing information, marks, promotional content, marketing content, contact information, business terms, transaction records, customer lists, payment methods, related services provided, or purchase options, in some embodiments.

Category information 430d may include information aspects related to product categories, inter alia, category names, super categories, sub categories, or images. Such information aspects may be images, descriptions, reviews, or links to apply categories as filters that may be structured as navigational breadcrumbs, in some embodiments. For example, the category breadcrumbs “All>Musical Instruments & Gear>Pro Audio Equipment>DJ & Monitoring Headphones” may be included, wherein each term includes a filter navigation to display a set of products related to the term's category, in some embodiments.

Locale information 430e may include information aspects related to physical locations, inter alia, addresses, geographic coordinates, location names, location descriptions, physical addresses, postal codes, or landmark names, in some embodiments.

Availability information 430f can include information aspects related to availability of products, services, or functions at businesses, inter alia, stock, count, pricing, shipping options, or engagement functions, in some embodiments. For example, a product at a retailer may have availability information related to it that indicates the product is “available for order,” in some embodiments.

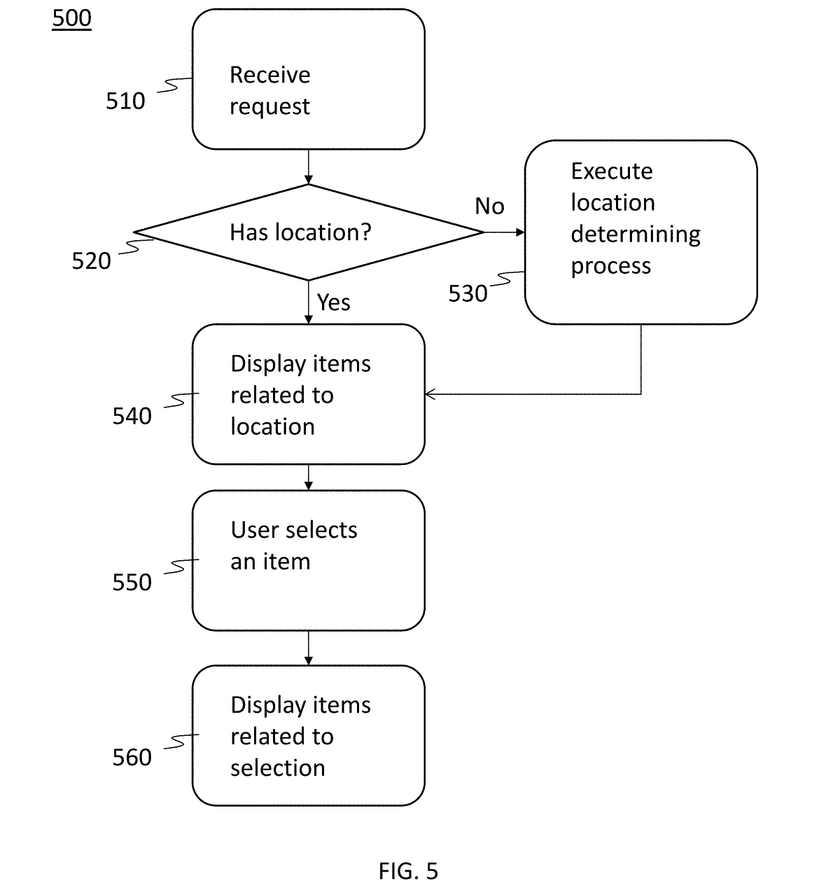

FIG. 5 illustrates an example 500 of a process for end-user navigation that includes a location determining process in accordance with some embodiments. A request can be received by the system in step 510, and logic 520 can determine if the request contains a location, in some embodiments. If there is no location related to the request, a location determining process can be executed in step 530, in some embodiments. Items can be displayed to the user that relate to the location in step 540, in some embodiments. The user can select an item in step 550, in some embodiments. In step 560, a new set of items related to the selection can be displayed, in some embodiments.

The location determining process in step 530 can include but is not limited to obtaining geographic coordinates via a GPS, using an IP address to approximate location, using a smartphone location service, using a browser-based location service, querying a location services API, or obtaining manual input from the end-user, in some embodiments.

Items referenced in step 540, step 550, and step 560 can include but are not limited to, inter alia, products, retailers, brand names, product categories, locations, product characteristics, business characteristics, available functions information (e.g., “only products that can be delivered” or “only retailers that appointments can be booked with”), promotional information, pagination, website navigation, or inventory characteristics (e.g., specific prices at retailers), in some embodiments.

In some embodiments, a web-based data system can have a control interface that lists data sources available to acquire data from, as well as the statuses of past extractions of data sources. Statuses can include “not executed,” “completed,” “in progress,” “failed,” and “manual activity required,” in some embodiments.

Commands can be displayed for each data source for the business-user to select, depending on the status related to each data source, in some embodiments. For example, commands may be “execute,” “cancel,” or “perform manual activity,” in some embodiments. The business-user can click a command to execute a series of automated steps related to the command that acquire and format data from the related source into a desired format such as a JSON or XML format that can be understood by a web server, in some embodiments.

The data acquisition steps for a single source may include a sequencing of accessing web API endpoints that expose product information in a third party system to acquire data, transforming the acquired data from an XML to a JSON format, downloading related media such as images and video, changing values of a subset of fields of the acquired data to correct misspellings and adding or modifying HTML tags to a subset of the acquired data for display, adding values to the data to create unique identifiers of a pre-determined format, and finally writing the data to a structured JSON file that can be understood by a web server, in some embodiments.

The business-user can perform manual activities related to data acquisition and transformation, in some embodiments. Upon clicking the command “perform manual activity,” the control interface displays a manual activity prompt for business-user input, in some embodiments. The manual activity prompt can vary depending on the type of manual activity required, but can include but is not limited to multiple choice selections, text input, or a visual representation of data operations, in some embodiments. This embodiment may associate one or more cached functions resulting from the partially complete execution of data acquisition and transformation with the manual activity prompt, in some embodiments. For example, the manual activity prompt may ask the business-user to select whether a new data record matches an existing data record or not, executing the cached function using the business-user's selection as input to produce an output that can be factored by the remainder of the data acquisition and transformation execution, in some embodiments.

The control interface can also list data destinations to send the processed data to (in this example, the processed JSON file, images, and media), for example, a shared cloud storage facility accessed by a web server, in some embodiments. Alternatively, the web-based data acquisition and transformation system may use the shared cloud storage facility for some or all data storage automatically without business-user intervention, in some embodiments. The system can notify a web server that new data is available to be consumed, optionally triggering a process on the web server to consume the data for display. Such notifications may be optionally triggered by the business-user selecting a data destination, in some embodiments.

In some embodiments, the web server constructs and serves landing pages for the purpose of enabling consumers or machine agents, i.e., end-users, to find or identify products carried locally by retailers through a variety of online channels.

The landing pages constructed by the web server can be dynamically generated by a computer program factoring groups of data, templates, styles, and branding assets based on the information contained within a request that the end-user sends to the web server, in some embodiments. The landing pages can be served to the user and may be displayed by a web browser, in some embodiments. These landing pages may be cached upon creation for future access, in some embodiments. Those skilled in the art will appreciate that a variety of programmatic generation, caching, and serving methodologies may be employed by the web server, in some embodiments. The landing pages serve a variety of purposes to inform end-users about businesses, brands, products, or services, in some embodiments.

In some embodiments, a programming framework can be used to create data sources and data destinations. Such a framework can enable a software developer to write individual functions, methods, or classes (i.e., functions) that perform tasks such as loading data from a source into memory, transforming the data, combining the data with additional data from additional data sources, and sending the data to a destination, in some embodiments. The programming framework may perform organizational tasks, such as dividing a data source of many records into individually accessible records, in some embodiments. The programming framework may perform common tasks such as iteration over a set of records, applying said functions to individual records, data input/output, metrics recording and tracking, multiprocessing, and creating a control interface to said functions in a way transparent to the software developer, in some embodiments.

These records may contain information directly from the data source, or additional data added by the programming framework or explicitly annotated by way of individual functions, methods, or classes, in some embodiments. Such additional data may serve the purpose of tracking history, tracking changes, measuring times, reporting errors, or tracking state of records, in some embodiments.

Those skilled in the art will appreciate that such additional data may be stored with or apart from the record in one or many computer storage systems, and may be aggregated on a rolling basis or explicitly linked to each record, in some embodiments.

An example function of some embodiments may perform the task “parse the physical address in each datum, send the result to a geo-coding API service, and record the result latitude and longitude to the respective record,” as implemented by the software developer in accordance with his or her goals. The programming framework additionally can enable an interface to the present example function that may be read by a web interface for human users or programmatic scheduler, in some embodiments. Such an interface can include a “run” function that applies the example function across a data set, as well as a set of parameters that may include a mode of function application, in some embodiments. Example modes of function application may be synchronous or asynchronous by way of, inter alia, a single thread or process, a queuing system, a message broker, multiple threads, a map-reduce process, or multiple processes, in some embodiments.

Those skilled in the art will appreciate that such synchronous or asynchronous modes of function application may be enabled by a wide breadth of computer system architectures and technologies, in some embodiments.

Appendix SRC. 1 illustrates an example of one such implementation of the interface, wherein a FileRecordBank class can provide methods to apply a function that is provided as input to a set of records in a directory of a file system, in some embodiments. This example implementation can control various modes of function application via the ASYNC parameter provided at class initialization, not exemplified, in some embodiments. This example implementation additionally can track a “call_count” metric to count the number of records a function is applied to, in some embodiments.

The interface to the present example function may be automatically generated by way of the programming framework, and may include additional functionality such as diagnostics, success metrics of function applications, error reporting, event logging, timestamps, manual activity interfaces, or input parameters to the example function, in some embodiments. Such an interface may incorporate the present example function in a grouping of additional functions to accomplish a larger logical task such as “Download data related to multiple business locations, format each datum into a key-value object, add the latitude and longitude parameters, and load to a database,” in some embodiments.

Appendix SRC. 2 illustrates an example of one such implementation of the programming framework described in the present example embodiment, wherein a central StepGroupRegistry and multiple subclasses of Step provide methods that a user interface may use to display controls, forms, and statuses relating to execution, in some embodiments. In some embodiments, a database backend can record the return values of Step.run( ). By using this programming framework, in some embodiments, a software developer may override the run( ) method with customized logic (i.e., a function) that performs an arbitrary task, which may include data transformation. The software developer may also implement a customized form by subclassing StepParamsForm to enable the user interface to accept additional input for the run( ) method, in some embodiments.

Those skilled in the art will appreciate that such an interface may be exposed to human input by way of, inter alia, a web interface or mobile application or exposed to another programming construct (i.e., machine input) such as a job scheduler or machine agent, in some embodiments. Such a machine agent may monitor the system for internal API calls, inbound web API calls, or changes in system state (e.g., the presence of a file, modification of a file system, or modification of a database), in some embodiments.

Such an interface may enable single or groups of functions to be run together by a human or machine agent, in some embodiments. The programming framework may perform optimizations or routings when running multiple functions, such as, inter alia, establishing an order of execution, establishing dependencies, or allocating tasks to particular computer resources, in some embodiments. Such optimizations or routings may be determined by the framework or explicitly declared by the software developer, in some embodiments.

As an example use case of some embodiments, the software developer may write and run the aforementioned example function to obtain latitude and longitude via an automatically generated web interface. As is common in software development, the developer may have forgotten to ensure the parsed physical address is valid input for the geocoding API, resulting in a large number of failures when running the function over a data set. In this example use case, in some embodiments, the programming framework may track the failures, and, recognizing them as a single failure mode, aggregates the failures to show the software developer a message like “522 exceptions of type InvalidApiRequestParameters, example stack trace below from record 333: [ . . . ]” This message can provide useful feedback to the software developer about the mode of failure of a system that may or may not be remote, or include multiple computers, multiple databases, or parallelism so that the software developer can quickly take appropriate corrective action with the example function, in some embodiments.

In some embodiments, a programming framework may be used to create the style and branding rules of a web page to be served to an end-user. Such a programming framework may include a “CustomizationDetector” class that implements a condition check, optionally returning a file directory of web templates (i.e., rules to generate HTML) specifically developed for a particular style and branding, in some embodiments.

Appendix SRC. 3 illustrates and example of one such implementation of the programming framework described in the present example embodiment, wherein a central CustomizationDetectorRegistry and multiple subclasses of CustomizationDetector provide methods that other programming logic can use to determine if a customized directory should be first searched for templates, or if default template behavior should be used.

Those skilled in the art will appreciate that such a file directory may be namespaced for use in an override mode of operation with respect to a default set of web templates, in some embodiments. Such templates may include references to various assets, such as, inter alia, additional templates, images, and CSS files, in some embodiments.

Those skilled in the art will appreciate that subclasses of CustomizationDetector may implement arbitrary programming logic to determine their return value, including inspection and analysis of the web request, in some embodiments.

In some embodiments, style and branding rules may be maintained in a database, file system, or by other means (i.e., database) such that the rules are configurable by a non-technical business user to be valid or invalid under certain conditions, and configurable as to the way that the rule changes the user interface if the rule is valid. Upon receiving a web request, such style and branding rules can be retrieved from the database and programmatically checked against the data in the web request, in some embodiments. In the case that a rule is valid, logic may be executed against the rule configuration to replace templates or various assets that affect the user interface such as, inter alia, images, text, or CSS, in some embodiments.

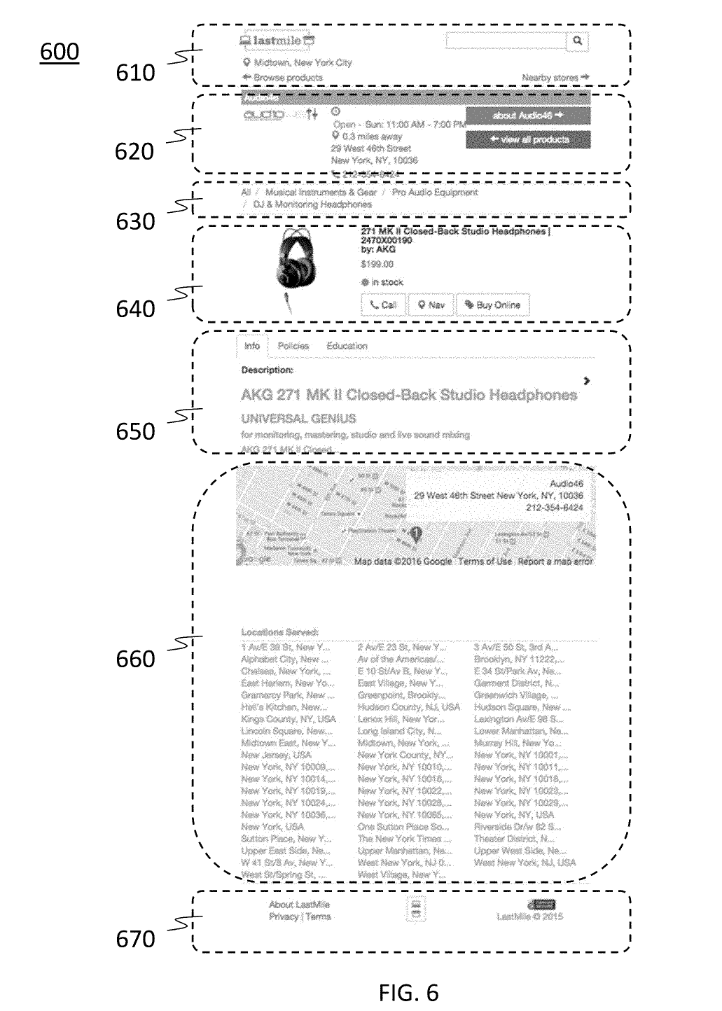

FIG. 6 illustrates an example 600 of a landing page and its constituent components in accordance with some embodiments. The specific set of components can result in a functional product-at-business landing page, in some embodiments. Structured data, not depicted, can exist on the landing page to enable machine readability by systems such as search engine spiders, in some embodiments.

Component 610 can contain global navigation functionality such as “change location,” “view products” and “nearby stores,” in some embodiments. Component 610 can also display a geographic constraint (e.g., “Midtown, New York City”), in some embodiments.

Component 620 can contain business information and navigation functionality related to a selected business such as name, address, phone number, open hours, “view all products,” and “about the business,” in some embodiments.

Component 630 can contain category information in the form of product or business category filters, in some embodiments. Component 630 can enable navigation based on these category filters, in some embodiments.

Component 640 contains product information, inventory information, and related functionality to call, navigate, or buy online, in some embodiments.

Component 650 can contain product or business information such as product descriptions, business policies, and business-related educational material, in some embodiments. Component 650 may contain arbitrary information, web-based forms, references to websites, or references to API endpoints, in some embodiments.

Component 660 can contain locale information such as the business's address, a map, and a list of locations related to the business's address, in some embodiments. Component 660 may also enable navigational functionality such as “change location according to map” or functionality specific to a location such as “call” or “navigate,” in some embodiments.

Component 670 can contain additional global navigation functionality such as “about,” “privacy,” and “terms of use,” in some embodiments.

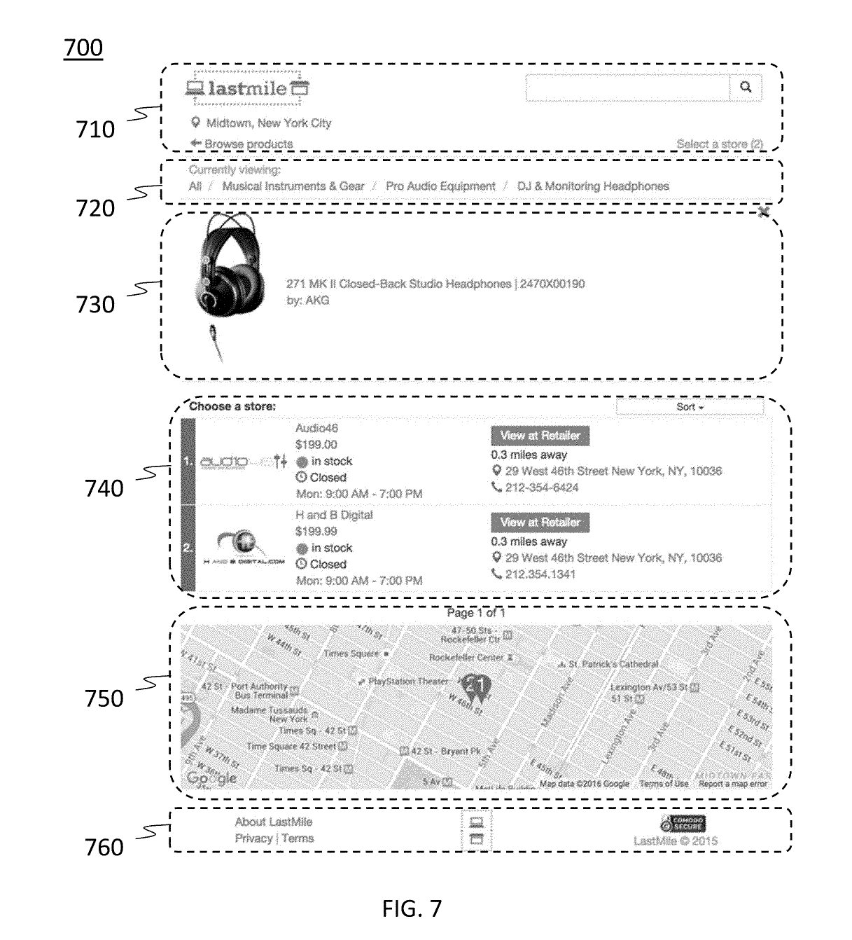

FIG. 7 illustrates an example 700 of a landing page and its constituent components in accordance with some embodiments. The specific set of components can result in a functional product-near-location landing page (i.e., list of businesses carrying a specific product), in some embodiments. Structured data, not depicted, can exist on the landing page to enable machine readability by systems such as search engine spiders, in some embodiments.

Component 710 can contains global navigation functionality such as “change location,” “view products” and “nearby stores,” in some embodiments. Component 710 can also includes a geographic constraint (e.g., “Midtown, New York City”), in some embodiments.

Component 720 can contain category information in the form of product or business category filters, in some embodiments. Component 720 can enable navigation based on these category filters, in some embodiments.

Component 730 can contain product information including a photograph, name, serial number, and brand, in some embodiments. Component 730 can enable navigation to view more about the product, or to remove the product context from navigation (i.e., view all businesses without constraining results by product), in some embodiments.

Component 740 can contain business information related to a plurality businesses including logos, hours of operation, stock statuses for a selected product, prices for a selected product, addresses, and phone numbers, in some embodiments. Component 740 can also enable functionality such as “navigate to store” and “call store,” in some embodiments. Component 740 can enable navigation to view more about each business or to view the details of the product in the context of the selection of a particular business, in some embodiments.

Component 750 can contain locale information such as business' addresses, a map, and a list of locations related to the business' address, in some embodiments. Component 750 may also enable navigational functionality such as “change location according to map” or functionality specific to a location such as “call” or “navigate,” in some embodiments.

Component 760 can contains additional global navigation functionality such as “about,” “privacy,” and “terms of use,” in some embodiments.

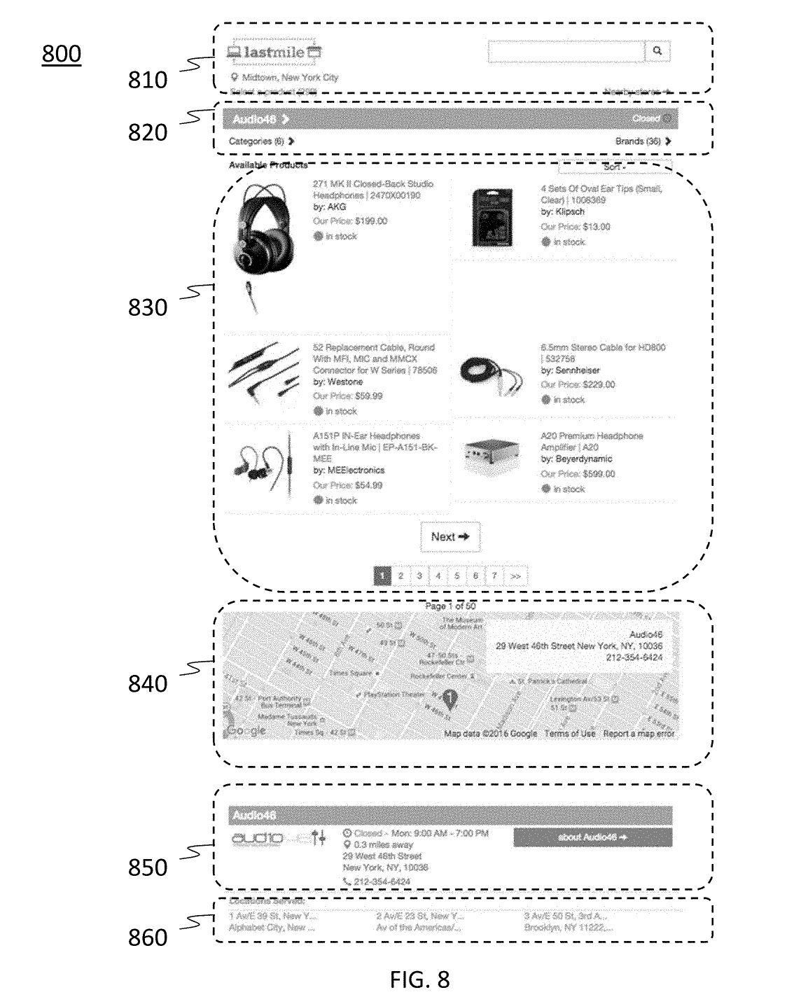

FIG. 8 illustrates an example 800 of a landing page and its constituent components in accordance with some embodiments. The specific set of components can result in a functional product-list-at-business landing page, in some embodiments. Structured data, not depicted, can exist on the landing page to enable machine readability by systems such as, inter alia, search engine spiders, in some embodiments.

Component 810 can contain global navigation functionality such as “change location,” “view products” and “nearby stores” (i.e., de-select business), in some embodiments. Component 810 can also include a geographic constraint (e.g., “Midtown, New York City”), in some embodiments.

Component 820 can contain business information and navigation functionality related to a selected business such as name, address, phone number, open hours, and “about the business,” in some embodiments. Component 820 can additionally contain category and brand filters related to the field of products listed below, in some embodiments.

Component 830 can contain product information including photographs, names, serial numbers, brands, stock statuses at the selected business, and prices at the selected business, in some embodiments. Component 830 can enable navigation to view more about each product, in some embodiments.

Component 840 can contain locale information such as the business's address and a map, in some embodiments. Component 840 may also enable navigational functionality such as “change location according to map” or functionality specific to a location such as “call” or “navigate,” in some embodiments.

Component 850 can additionally contain business information and navigation functionality related to a selected business such as name, address, phone number, open hours, “view all products,” and “about the business,” in some embodiments.

Component 860 can contain a list of locations related to the business's address, in some embodiments.

The landing pages depicted in FIG. 6, FIG. 7, and FIG. 8 can enable several marketing functions for retailers, brands, or manufacturers, in some embodiments. Such marketing functions may include but are not limited to serving as landing pages for digital advertisements (i.e., digital advertisements on third party websites or applications link to landing pages), obtaining organic search visibility via third party keyword-ranking algorithms (i.e., enabling search engines to rank landing pages), and facilitating interactions with consumers such as buy-online for pickup, book appointment, call, and navigate, in some embodiments. Additionally, not depicted, the landing pages can enable the presentation of machine-readable information relating to the landing pages' composing information for the purposes of search engine optimization, in some embodiments.

Those skilled in the art will appreciate that landing pages fulfilling various functional roles (e.g., inter alia, business list for a specific product, product list for a specific category, business list for a specific category, example landing page 600, example landing page 700, example landing page 800) may be constructed with various sets of data components, that components may comprise any set of information, and that landing pages fulfilling such functional roles may enable such marketing functions, in some embodiments. Moreover, landing pages may track consumer usage metrics by logging server-side events or by enabling a client-side script that sends usage metrics to a logging server, in some embodiments.

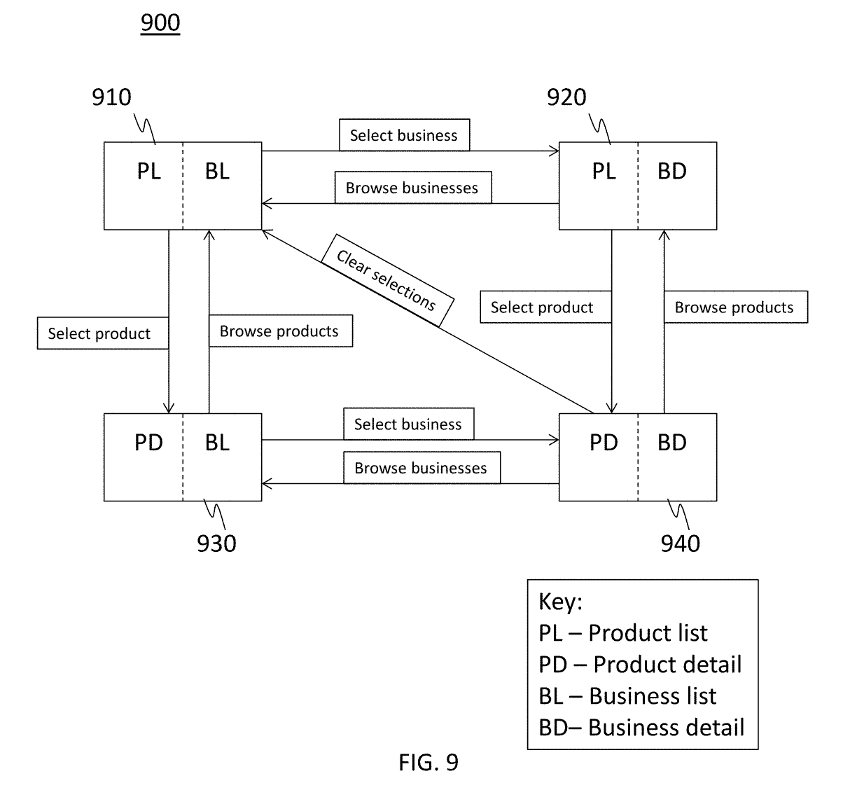

FIG. 9 illustrates an example 900 of a pattern of system state 910, system state 920, system state 930, and system state 940 for displaying product and business landing pages (labeled “PL,” “PD,” “BL,” “BD”) for display to an end-user for the purposes of navigating product, business, and inventory information in accordance with some embodiments. Additionally, the relationships from one system state to another via navigation functionality are illustrated, in some embodiments.

System state 910 can represent a state in which no specific product or business is selected, in some embodiments. Navigation functionality within system state 910 may include but is not limited to viewing a list of products or viewing a list of businesses, in some embodiments. Additionally, system state 910 may enable navigation functionality to change system states including but not limited to select product or select business, in some embodiments.

System state 920 can represent a state in which a specific business is selected and no specific product is selected, in some embodiments. Navigation functionality within system state 920 may include but is not limited to viewing a list of products related to the selected business (e.g., a list of products carried by the selected business) or viewing details related to the selected business, in some embodiments. Each listing within the list of products may display additional information related to the combination of the listed product and selected business (e.g., inventory information about the listed product at the selected business), in some embodiments. Additionally, system state 920 may enable navigation functionality to change system states including but not limited to select product or browse businesses, in some embodiments.

System state 930 can represent a state in which a specific product is selected and no specific business is selected, in some embodiments. Navigation functionality within system state 930 may include but is not limited to viewing the details of the selected product or viewing a list of businesses related to the selected product (e.g., a list of businesses carrying the selected product), in some embodiments. Each listing within the list of businesses may display additional information related to the combination of the selected product and listed business (e.g., inventory information about the selected product at the listed business), in some embodiments. Additionally, system state 930 may enable navigation functionality to change system states including but not limited to browse products or select business, in some embodiments.

System state 940 can represents a state in which a specific product is selected and a specific business is selected, in some embodiments. Navigation functionality within system state 940 may include but is not limited to viewing the details of the selected product or viewing the details of the selected business, in some embodiments. Said details may include additional information related to the combination of the selected product and the selected business (e.g., inventory information about the selected product at the selected business), in some embodiments. Additionally, system state 940 may enable navigation functionality to change system states including but not limited to browse products, browse businesses, or clear selections, in some embodiments.

Those skilled in the art will appreciate that system states within pattern 900 may be implemented by way of a stateless request and response system (i.e., a web server), wherein state transitions are facilitated by hyperlinks to other web pages, in some embodiments. For example, system state 910 may be addressed at the link “/” (i.e., root), with the rendered web page including links to system states 920 and 930 via the links “/joes-headphone-store/” (i.e., select business) and “/audiotechnica-headphones-xyz123/” (i.e., select product) respectively, in some embodiments. Further, system states 920 and 930 may include links to system state 910 and 940 via the links “/” and “/joes-headphone-store/audiotechnica-headphones-xyz123/” respectively, in some embodiments.

Those skilled in the art will appreciate that system states within pattern 900 may be alternatively be implemented by a state-maintaining object, such as a web cookie, accompanying web requests, in some embodiments. Such a state-maintaining object may maintain state within the object, transmitting it to a web server with each web request, or the object may comprise a reference to a representation of state that is maintained in a database, file system, or the like accessible to the web server, in some embodiments.

Those skilled in the art will appreciate that pattern 900 may incorporate information that may include but are not limited to, inter alia, brand information, location information, product information, business information, related or similar brands, related or similar locations, related or similar products, related or similar businesses, count, names, identifiers, descriptions, specifications, images, video content, instructional documents, marketing material, reviews, ratings, pricing information, marks, promotional content, marketing content, contact information, business terms, transaction records, customer lists, payment methods, related services provided, or purchase options, in some embodiments.

Those skilled in the art will appreciate that pattern 900 may incorporate navigational functions not illustrated, that may include but are not limited to a combination of, inter alia, obtain location from end-user, search for product, search for business, search for brand, search for product category, search for location, view business-related information, view product-related information, view brand-related information, change location, change business, select related products, or constrain by interactive function (e.g., show only businesses that support appointment booking or buy online and pick up in store), in some embodiments.

Those skilled in the art will appreciate that pattern 900 can be extended to include navigation functionality outside of only product and business related system states, inter alia, selecting or not selecting a brand, selecting or not selecting a location, selecting or not selecting a category, or performing a search, in some embodiments.

Those skilled in the art will appreciate that pattern 900 can be extended to include landing pages outside of only product and business (i.e., product dimensions and business dimensions) related landing pages as combinations of one or many functional roles, inter alia, product landing pages, business landing pages, brand landing pages, category landing pages, or location landing pages by introducing additional dimensions such as, including but not limited to, location, brand, manufacturer, or category, in some embodiments. For example, a brand-at-business landing page may comprise information related to products carried by a particular retailer that additionally relate to (i.e., are manufactured by) a particular brand or group of brands, in some embodiments. As an additional example, a brand-at-location landing page may comprise information related to products carried by retailers nearby a location that additionally relate to (i.e., are manufactured by) a particular brand or group of brands, in some embodiments.

Those skilled in the art will appreciate that pattern 900 may incorporate context-specific interactive functions not illustrated, that may include but are not limited to a combination of, inter alia, buy online for pick up, buy online for delivery, schedule an appointment, call, or navigate, wherein such functions may or may not be present based on the context of the system state (e.g., an appointment booking interactive function appears when a business that supports appointment booking is selected and a user is authenticated or “logged in”), in some embodiments.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

```
APPENDIX SRC. 1
“““
SRC. 1 - function application, mode selection, and annotation of metrics
(non-working source code for illustration)
”””
class FileRecordBank( ):
    def _call_(self,
                record_name,
                func,
                func_kwargs={ },
                input_field=None,
                output_field=None,
                step_number=None):
        “““
        Calls apply_func_to_record with appropriate params
        ”””
        if type(func) is not str:
            func = fqn(func)
        self._count_calls(step_number=step_number, func_fqn=func)
        record_path = self._get_record_path(record_name)
        if self.ASYNC:
              apply_func_to_record =
        apply_func_to_record.run_async else:
              apply_func_to_record = apply_func_to_record
        _apply_func_to_record(
            record_path, func, func_kwargs, input_field,
            output_field, self.EXC_HANDLER, step_number
        )
        return self.CALL_COUNT # reports number of records applied
    to def _iter_(self):
        return self
    def _next_(self):
    try:
        return self.PATH_GENERATOR._next_( )
    except StopIteration:
        self.PATH_GENERATOR = self._path_generator( )
        raise
def _path_generator(self):
    # used to instantiate PATH_GENERATOR on _init_( )
    return Path(self.DIRECTORY).iterdir( )
def run_all(self, limit=None, step_number=None, **kwargs):
    for count, path in enumerate(self):
        if limit and count >= limit:
            break
        if path.suffix == self.FILE_SUFFIX:
            self._call_(record_name=path.name.rsplit(‘.’, 1)[0],
                        step_number=step_number,
                        **kwargs)
    cc = self.CALL_COUNT.copy( )
    self.CALL_COUNT = { }
    return _format_call_count(cc)
```

```
APPENDIX SRC. 2
“““
SRC. 2 - programming framework for organizing transformation functions
and generating an interface (non-working source code for illustration)
”””
class StepGroupRegistry( ):
    “““
    A registry of step groups used to find subclasses of StepGroup and
Step for rendering.
    ”””
    def _init_(self):
        self.registry = [ ]
    def register(self, step_group):
        self.registry.append(step_group)
    def get_all_step_groups(self):
        return [group for group in self.registry if group.steps( )]
    def get_step_group(self, step_group_fqn):
        for sg in self.registry:
            if sg.label( ) == step_group_fqn:
                return sg
        return None
class StepGroupMetaClass(type):
    def _new_(cls, *args, **kwargs):
        new_step_group = super( )._new_(cls, *args, **kwargs)
        step_group_registry.register(new_step_group)
        return new_step_group
class StepParamsForm(WebForm):
    active = BooleanField( )
class Step( ):
    def _run(self, step_params, step_number):
        active = step_params.pop(‘active’, False) # check boxes return
True or aren't present
        if active:
            result = self.run(step_params, step_number)
        else:
            result = ‘Skipped %s’ % self.get_name( )
        return result
    def get_name(self):
        return self._class_._name_{—}
    def get_step_params_form(self):
        “““
        Returns a form that can be rendered, uses partial for receiving
        data.
        Namespaced by the Step's class name (every step should be
a unique class).
        ”””
        return partial(StepParamsForm, prefix=self.get_name( ))
    def run(self, step_params, step_number):
        “““
        Implemented by the user to define the activities to run during
this step.
        Returns a tuple of (message, data) to be displayed to the user.
        step_params is intended to be key, value pairs mapping
to the form used in
            get_step_params_form( )
        ”””
        pass
class StepGroupBase( ):
    @classmethod
    def label(cls):
        return fqn(cls)
    @classmethod
    def get_form_list(cls):
        “““
        Returns a form built from each of the get_form methods of this
StepGroup's Steps.
        ”””
        return [step.get_step_params_form( ) for step in cls.steps( )]
    @abc.abstractmethod
    def steps( ):
        “““
        Returns a list of Step classes to be executed in order.
        ”””
        return [ ]
class StepGroup(StepGroupBase, metaclass=StepGroupMetaClass):
    “““
    StepGroup that is synced with StepGroupRegistry.
    ”””
    pass
```

```
APPENDIX SRC. 3
“““
SRC. 3 - programming framework for selecting HTML template
overrides (non-working source code for illustration)
”””
class CustomizationDetectorRegistry( ):
    “““
    A registry of customization detectors that each check conditions to
determine if an override
    directory should be provided for use by add_template_dirs.
    ”””
    def _init_(self):
        self.registry = [ ]
    def register(self, detector):
        self.registry.append(detector)
    def check(self, request, *args):
        ‘‘‘
        Iterates through registry, calling detect( ) on each object.
        Returns the first True value, otherwise returns None
        ’’’
        detect_dict = request.kwargs
        detect_dict.update(request.GET)
        for customization_override_detector in self.registry:
            if customization_override_detector.detect(detect_dict,
                *args): return
customization_override_detector.detect(detect_dict, *args)
        return None
class CustomizationDetectorMetaClass(type):
    def _new_(cls, *args, **kwargs):
        new_detector = super( )._new_(cls, *args, **kwargs)
        customization_template_override_registry.register
        (new_detector) return new_detector
class CustomizationDetector(metaclass=CustomizationDetectorMetaClass):
    @classmethod
    @abc.abstractmethod
    def detect(cls, detect_dict, *args):
        “““
        Implementation should return either a string representing
a template directory or None.
        ”””
        pass
```

What is claimed is:

1. A method for providing aggregated and uniformly arranged item information, comprising:
receiving at a local computing device, from each of a plurality of item sources, item information for each of a plurality of items, wherein the item information from each of the plurality of item sources is in a different format;
transforming the item information from at least one of the plurality of item sources into a common format;
receiving a location identifier;
receiving at least one parameter including at least one of an item identifier and a source identifier, wherein the item identifier identifies at least one of the plurality of items, and wherein the source identifier identifies at least two of the plurality of item sources;
selecting item information based on the at least one parameter and the location identifier;
aggregating the selected item information and arranging the aggregated item information into a uniform format; and
transmitting the arranged information from the local computing device to a remote computing device.

2. The method of claim 1, wherein each of the at least two of the plurality of item sources are identified by the source identifier based on a distance from the item source to the location.

3. The method of claim 1, wherein the item information for an item includes a distance from an item source corresponding to the item to the location.

4. The method of claim 1, wherein selecting item information for an item is based on a distance from an item source corresponding to the item to the location

5. The method of claim 1, wherein the item information for an item includes a link to an item source corresponding to the item.

6. The method of claim 1, wherein the at least one parameter includes: at least one item identifier; and at least one source identifier.

7. A system for providing aggregated and uniformly arranged item information, comprising:
a memory; and
at least one hardware processor configured to:
receive from each of a plurality of item sources, item information for each of a plurality of items, wherein the item information from each of the plurality of item sources is in a different format;
transform the item information from at least one of the plurality of item sources into a common format;
receive a location identifier;
receive at least one parameter including at least one of an item identifier and a source identifier, wherein the item identifier identifies at least one of the plurality of items, and wherein the source identifier identifies at least two of the plurality of item sources;
select item information based on the at least one parameter and the location identifier;
aggregate the selected item information and arrange the aggregated item information into a uniform format; and
transmit the arranged information to a remote computing device.

8. The system of claim 7, wherein each of the at least two of the plurality of item sources are identified by the source identifier based on a distance from the item source to the location.

9. The system of claim 7, wherein the item information for an item includes a distance from an item source corresponding to the item to the location.

10. The system of claim 7, wherein selecting item information for an item is based on a distance from an item source corresponding to the item to the location

11. The system of claim 7, wherein the item information for an item includes a link to an item source corresponding to the item.

12. The system of claim 7, wherein the at least one parameter includes: at least one item identifier; and at least one source identifier.

13. A non-transitory computer-readable medium containing computer executable instructions that, when executed by a processor, cause the processor to perform a method for providing aggregated and uniformly arranged item information, the method comprising:
receiving at a local computing device, from each of a plurality of item sources, item information for each of a plurality of items, wherein the item information from each of the plurality of item sources is in a different format;
transforming the item information from at least one of the plurality of item sources into a common format;
receiving a location identifier;
receiving at least one parameter including at least one of an item identifier and a source identifier, wherein the item identifier identifies at least one of the plurality of items, and wherein the source identifier identifies at least two of the plurality of item sources;
selecting item information based on the at least one parameter and the location identifier;
aggregating the selected item information and arranging the aggregated item information into a uniform format; and
transmitting the arranged information from the local computing device to a remote computing device.

14. The non-transitory computer-readable medium of claim 13, wherein each of the at least two of the plurality of item sources are identified by the source identifier based on a distance from the item source to the location.

15. The non-transitory computer-readable medium of claim 13, wherein the item information for an item includes a distance from an item source corresponding to the item to the location.

16. The non-transitory computer-readable medium of claim 13, wherein selecting item information for an item is based on a distance from an item source corresponding to the item to the location

17. The non-transitory computer-readable medium of claim 13, wherein the item information for an item includes a link to an item source corresponding to the item.

18. The non-transitory computer-readable medium of claim 13, wherein the at least one parameter includes: at least one item identifier; and at least one source identifier.
